(19) United States
(12) Patent Application Publication
(10) Pub. No.: US 2002/0157063 A1
(43) Pub. Date: Oct. 24, 2002

(54) Implicit mapping of technology independent network to library cells

(76) Inventor: Thierry D. Besson, Roquefort-les-Pins (FR)

Correspondence Address: Omkar K. Suryadevara, SKJERVEN MORRILL MacPHERSON LLP, Suite 700, 25 Metro Drive, San Jose, CA, 95110-1349, US

(21) Appl. No.: 09/752,304

(22) Filed: Dec. 28, 2000

(51) Int. Cl. G06F 17/50

(52) U.S. Cl. 716/1

(57) ABSTRACT

Portions of an electrical circuit described as a technology-independent network are automatically mapped by a computer to cells of a library to be used in manufacturing the circuit, using a common set of input signal names for both (the circuit and the cells). A computer readable medium stores models of cells of a library that were constructed using common input names, and also an association between each model and a cell that was used to create the model. In one embodiment, constructing models of the library cells includes reading first data from memory, wherein the first data corresponds to a first cell of the library of cells. The first data includes names representing input signals to the first cell. Thereafter, each name of the first data is replaced with a new name, respectively, thereby creating a first renamed data. A model of the first cell is generated from the first renamed data. In a similar manner, variable names in second data corresponding to a portion of the to-be-fabricated circuit are replaced with the just-described new names, thereby creating a second renamed data. When the second renamed data is used, a previously-generated model is found to represent the circuit portion, due to the common names, thereby to identify the first cell as implementing the circuit portion.

### CROSS-REFERENCE TO ATTACHED APPENDICES

Appendices A-G which are a part of the present disclosure, and which are incorporated by reference herein in their entirety, are attached herewith in paper form to be submitted as a microfiche consisting of a total of XXX sheets that contain a total of YYY frames.

Appendices A-E contain source code of computer programs and related data of an illustrative embodiment of the present invention, for use in a Personal Computer, such as a PC available from Dell Corporation and running the Microsoft NT Operating System, or an Ultra 2 workstation available from Sun Microsystems, Inc, running Unix or Solaris operating system also available from Sun.

Appendix B includes a file “gnlmap.h” which defines types and data-structures to store a Generic NetList (GNL). This file also defines special generic objects like generic flip-flop, latches, tristates. This file also includes a data-structure (referenced below) named “GNL_MAP_NODE_INFO” which attaches information to a node of the netlist. A node of a netlist is of type GNL_NODE (cf. ‘gnl.h’) and represents a Boolean functionality.

Appendix B also includes another file “gnlmap.c” which defines the routines (referenced below) to perform a general mapping (according the optimization criterion: area, speed, power, . . . ) of the input GNL netlist and maps it into cells of a specified target library. The main function called is “GnlMap” at the end of the file. The main function mapping Boolean equations is “GnlMapGnl”. For instance for the area criterion, it will call “GnlBestAreaMapNode” which performs the mapping (explained below) on a gnl node ‘Node’.

Appendix B further includes the file “gnllib.c” which analyzes a target library of cells and for each of them creates the set of BDD representants (described below). For each BDD constructed a pointer points back to the corresponding cell. This global work space which has been created (Cells info+ BDDs) are used when invoking the technology mapping (cf ‘gnlmap.c’) of any Boolean node of the current GNL netlist.

The software in Appendices A-E can be compiled with a C compiler, e.g. available from Microsoft or Sun. Appendix F contains documentation for the computer programs and data of Appendices A-E. Appendix G contains further documentation for the computer program, and theoretical basis thereof.

A portion of the disclosure of this patent document contains material which is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever.

### BACKGROUND

Generally, the design of integrated circuits (ICs) is a complicated process that involves the balancing of several competing design criteria including: minimization of substrate surface area occupied by the IC, maximization of operational speed of the IC, minimization of power consumption of the IC, etc. Today's ICs are growing in size which, in turn, increases the design complexity thereof. Today's ICs have become so complicated that their design often requires the use of automated design tools to assist a designer to, for example, balance the competing design criteria noted above.

Typically, the integrated circuit design is initially created by a designer in the form of Boolean equations or an HDL description in a language such as Verilog or VHDL (Very High Speed Integrated Circuits Hardware Description Language). The design is then converted to a network consisting of vertices or nodes representing gates and edges representing the nets connecting gate outputs to gate inputs. The gates in the network (also called “technology-independent network”) are generally primitive gates such as AND, OR, or NAND gates, and at this stage are independent of the technology to be used in fabrication of ICs.

One goal of automated design tools is to map a technology-independent network, into a network of cells (also called “CMDS logic cells”) that are specific to fabrication. Generally, automated design tools map portions of the technology-independent network to cells of a library (also called “technology-dependent library”) where each cell represents descriptions of layers of semiconductor material required to implement a gate (such as an AND gate or an OR gate) or circuit (such as a multiplexer, a latch or a flip-flop). The gates in the technology-dependent library may include primitive gates and gates with complex combinational functions. The result of mapping may be called a technology-mapped or technology-dependent network. The technology-dependent library used in automated design tools depends on the manufacturer of the IC and/or the technology used to manufacture the IC.

The technology-independent network is mapped using mapping software. Typically, some restructuring is performed by a designer to meet specified design criteria. The restructuring may involve a repetitive optimizing process in which changes are made to the network of cells with recalculations of various parameters after each change. The parameters may include propagation delay (signal speed) which is related to the time required for a change in one of the input signals to travel through the network, or portion thereof, to produce a corresponding change in an output signal. Another parameter is substrate surface area which relates to the number of transistors required to implement a given design, or a portion thereof. Still another parameter is signal drive strength which is related to the amount of current needed to drive an output of a gate to a desired signal level.

Many CAD tools in the area of circuit design use Binary Decision Diagrams (BDDs) as the underlying data structure to build models of the technology-independent network and the technology-dependent library, and thereafter compare the two types of models. A BDD is a directed acyclic graph (DAG) representation of a boolean function. The DAG has two terminal nodes labeled 0 and 1, representing the boolean values true and false. Each non-terminal node represents a boolean function. R. E. Bryant, “Graph-based algorithms for Boolean function manipulation,” IEEE Transactions on Computers, C-35, No. 8, pp. 667-691, 1986 (incorporated by reference herein in its entirety) introduced a reduced order BDD (abbreviated as ROBDD) data structure which is a canonical form, i.e. two boolean functions are equivalent if and only if they have the same ROBDD (assuming the same variable ordering). Bryant provided algorithms to transform a formula into a BDD and moreover he proved that logically equivalent formulae have identical ROBDD representants. ROBDDs are also described in S. Minato, N. Ishiura, S. Yajima, “Shared Binary Decision Diagrams with Attributed Edges for Efficient Boolean Function Manipulation,” Proceedings of 27^{th} Design Automation Conference, 1990, which is incorporated herein by reference in its entirety.

A website www.ics.ele.tue.nl/es/research/fv/research/research_bdd.html provides source code of a software package called “bdd” in which ROBDDs are used. The bdd package reads formulas in BDD syntax, builds a BDD graph and echoes it in sum-of-cubes representation to stdout. The bdd package is based on the article of Karl S. Brace et al, “Efficient Implementation of the BDD Package”in Proceedings of 27^{th} ACM/IEEE Design Automation Conference, pp. 4045, June 1990 (incorporated by reference herein in its entirety). The bdd package uses a hash table to maintain a strong canonical form for the ROBDD and to improve memory usage. By using dynamic variable ordering (see: Exploiting Structural Similarities in a BDD-based Verification Method (TPCD-94, Germany)) the influence of variable ordering on the size of the BDD representation is reduced.

As stated at the above-described website, the bdd package can be used to check if a function contains another function. In this case the implication is build as a ROBDD. The resulting graph can have: depth 0 and “1” as output: the implication is true (a tautology); depth 0 and “0” as output: the implication is unsatisfiable; depth >0: the implication is satisfiable. The bdd package can also be used to compare two designs. If you write two designs in the BDD-syntax you can compare the designs with each other by stating that the outputs are equivalent. The bdd package then builds one (canonical) graph which contains both descriptions. As output it uses a function (f) which is “0” when the output behaviour of the two designs differ and is “1” if the output behaviour is the same. If the descriptions have the same output-behaviour, the BDD graph will be of depth 0 and have the value “1” (for all input vectors, the outputs of both descriptions are the same).

Other examples of software for building BDDs are available from a number of sources over the Internet, including, for example the following:

Eindhoven BDD package:

http://www.cs.cmu.edu/afs/cs/usr/bwolen/Web/fmcad98/packages/ehv.html

Berkeley BDD package:

http://www-cad.eecs.berkeley.edu/Respep/Researchlbdd/call_bdd/

Boulder Bdd package:

http://www.elen.utah.edu/˜jiunbin/cudd/

CMU Bdd package:

http://www.cs.cmu.edu/afs/cs.cmu.edu/user/bwolen/www/software/ppbf/README

More information on BDDs and ROBDDs is available on the Internet at the website www.ee.pdx.edu/˜alanmi/research/bdds.htm.

### SUMMARY OF THE INVENTION

The present invention relates to mapping portions of an electrical circuit (in the form of a technology-independent network) to cells to be used in fabrication, by use of common names (also called variables) for (1) signals in the electrical circuit and (2) signals input to the cells. In one embodiment, common names are used to build a model (also called “circuit model” , such as a BDD or ROBDD) of at least a portion of the electrical circuit, and also to build models of cells. During construction of a model of one type (e.g. the circuit model), use of common names causes a portion of a previously-constructed model of the other type (e.g. a cell model) to be identified, thereby eliminating the prior art need to explicitly compare models of the two types, after both types of models are constructed. In the just-described example, a previously-constructed cell model may be identified as forming the circuit model (or a portion thereof) if a corresponding cell exists in the library.

In one implementation of such an example, constructing models of the library cells includes reading from the library data (also called “first data”) that includes names of signals being input to a cell. Thereafter, the names are replaced with new names (such as a set of predetermined names that are also used (or to be used) for signals in the electrical circuit), thereby to yield data containing the new names (also called “first renamed data”). Next, a model of the cell is constructed using the first renamed data.

Depending on the embodiment, construction of the cell model may include generating binary decision diagram (BDD) or reduced order binary decision diagram (ROBDD) data from the first renamed data. The BDD (or ROBDD) data may be generated using a BDD (or ROBDD) builder, which may be of a type well known in the prior art. A relation between the BDD (or ROBDD) data and the cell is established and stored in memory for future reference, in one implementation. In one example of the relation, an identifier of a cell (such as the cell's memory address in the library) is stored in a location adjacent to the BDD (or ROBDD) data (which requires expanding a prior art data structure used to hold the BDD or ROBDD data in the builder, to accommodate the identifier). In another example of the relation, a hash table external to a prior art BDD package is used, to relate BDDs and identifiers of cells that generated the BDDs. After a circuit model has been built, a cell related to the electrical circuit portion being modeled is identified by simply looking up the identifier. Note that a number of cells may be related be related to the same model, e.g. if the cells differ only in the value of a physical parameter, such as propagation delay, power and surface area.

Modeling all (or substantially all) cells in the library before modeling the electrical circuit enables circuitry to be automatically and implicitly mapped to cells in the library, in accordance with one embodiment. In this embodiment, models of portions of the circuitry are created using some or all of the new names used in creating models of the library cells. For example, data (also called “second data”) representing a portion of circuitry may be read from memory. This second data includes names of signals that are input to the circuitry. If these names are different from the above-described new names, these names are replaced with the new names (described above), to obtain second renamed data. Thereafter, models of the circuitry, such as BDD (or ROBDD) data, are generated from the second renamed data, e.g. by using the above-described BDD (or ROBDD) builder. If a cell, corresponding to the circuitry portion being modeled, exists in the library, a corresponding model, e.g. BDD (or ROBDD) data would have already been generated from the first renamed data. So a BDD (or ROBDD) builder returns the previously generated BDD (or ROBDD) data, and the above-described relation between the data and the cell is used to identify the corresponding library cell(s). If no match is found, the BDD (or ROBDD) data may be saved for later use.

In case of asymmetric cells, a number of cell models are built in one embodiment using different orders of names, to ensure that at least one of these cell models matches a circuit model (as the order of names of signals input to a circuit model depend on remaining portions of the electrical circuit). Therefore, a single asymmetric cell is related (as described above) to a number of models that differ only in the order of the input signals and/or inversion of one or more input signals. Use of multiple cell models for a single cell allows matching to occur implicitly when modeling portions of the circuitry, regardless of the order in which the names occur in the original cell and in the original circuitry.

### BRIEF DESCRIPTION OF THE DRAWINGS

FIG. 1 is a block diagram illustrating a computer system implementing the present invention;

FIG. 2 illustrates canonical representant set of exemplary functions built by the system of FIG. 1;

FIG. 3 illustrates data used to perform implicit matching of electrical circuitry (e.g. in the form of Boolean functions) to library cells by the system of FIG. 1;

FIG. 4 shows a more detailed example of CRS 306 of FIG. 3;

FIG. 5 illustrates a more detailed example of implicit matching in accordance with one embodiment of the present invention.

FIG. 6 is a flow chart illustrating one embodiment of constructing models of cells in accordance with the present invention;

FIG. 7 is a flow chart illustrating operational aspects of mapping candidate clusters to library cells in accordance with one embodiment of the present invention.

### DETAILED DESCRIPTION

Technology mapping in accordance with invention can be divided into at least two acts. In a first act, at each node of a technology-independent network, a set of nodes and edges having the node as the root may be selected. This set of nodes and edges represents a portion of the technology independent circuit design and may be referred to herein as a candidate cluster or simply “cluster”. In a second act, a check is performed to determine whether each cluster is realizable, i.e., if the cluster can be implemented by one or more cells from a library (which may or may not be a technology-dependent library). A cluster may be considered realizable if the cluster's function can be implemented by the function of a cell in the library, either directly, or by inverting the inputs, permuting the inputs, or inverting the outputs (i.e., if the cluster's function is NPN equivalent to a cell in the library). In the second act, the realizable clusters are used to completely cover the technology-independent network.

In one embodiment, boolean functions of clusters in the technology-independent network and cells in the technology-dependent library are not created separately and compared explicitly to determine equivalence. Instead, common names are used for signals input to cells and to a cluster so that an implicit matching is performed, e.g. while building a model, such as a BDD (or ROBDD).

Therefore, this embodiment eliminates the use of, e.g. Boolean function matching techniques described in J. R. Burch, D. E. Lond, “Efficient Boolean Function Matching,” Proceedings of the International Conference-Aided Design, 1992; and S. Ercolani, G. De Micheli, “Technology Mapping for Electrically Programmable Gate Arrays,” Proceedings of Design Automation Conference, 1991 and/or tree coverings as shown in K. Keutzer, “DAGON: Technology Binding and Local Optimization by DAG Matching,” Proceedings of Design Automation Conference, 1987, and/or use of defined signatures or keys for each cell as shown in U. Schlichtmann, F. Brglez, M. Hermann, “Characterization of Boolean Functions for Rapid Matching in EFPA Technology Mapping,” Proceedings of Design Automation Conference, 1992, and/or canonical keys as shown in U. Hinsberger, R. Kolla, “Boolean Matching for Large Libraries,” Proceedings of Design Automation Conference, 1998, all of which are incorporated herein by reference in their entirety.

Use of common names (also called “variables”) as described herein, in comparison with signature or key hashing based methods of the prior art, avoids hashing collision and also avoids Boolean functional comparisons (which are computationally expensive).

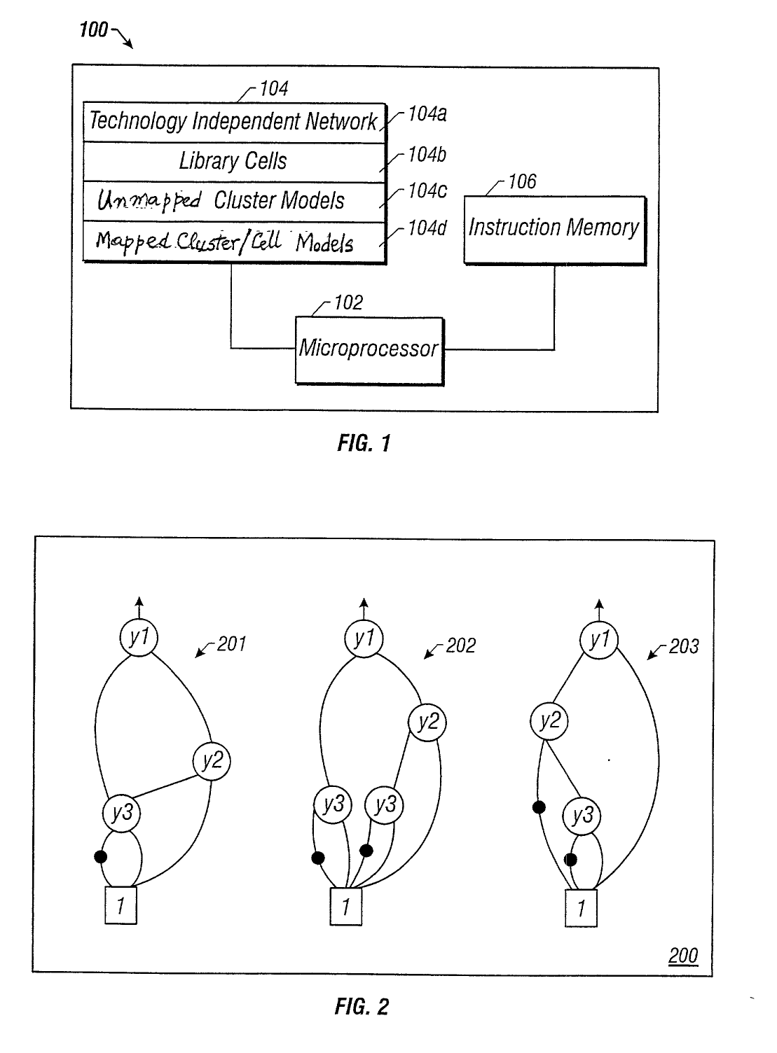

FIG. 1 is a block diagram illustrating a computer system 100 of one embodiment that is used for building models of library cells and for implicitly mapping candidate clusters to cells of the library, by using the cell models during modeling of candidate cluster. Computer system 100 can be a Personal Computer, such as a PC available from Dell Corporation and running the Microsoft NT Operating System, or an Ultra 2 workstation available from Sun Microsystems, Inc, running Unix or Solaris operating system also available from Sun.

Computer system 100 includes a microprocessor 102, a data memory 104 and an instruction memory 106. Data memory 104 may include a memory 104a for storing data relating to a technology-independent network representing a to-be-fabricated electrical circuit, a memory 104b for storing data relating to the cells of a technology-dependent library, and a memory 104d for storing models of the cells. Data memory 104 may optionally include an additional memory 104c for storing models of clusters which do not have a corresponding cell model in memory 104d. Instruction memory 106 stores microprocessor executable instructions for building the models (of the cells and the clusters), and/or other microprocessor executable instructions for processing the network in memory 104 or the models in memories 104d and 104c.

Microprocessor 102 responds to and processes instructions contained in instruction memory 104. Memories 104 and 106 or portions thereof can be, e.g., a CD ROM, or floppy disks; a volatile computer system memory such as DRAM, SRAM, rambus RAM, etc.; or a non volatile memory such as optical storage or magnetic medium, e.g., a hard drive. The term “memory” is used interchangeably with “memory medium” herein. Memories 104 and/or 106 can include other types of memory or combinations thereof. Memories 104 and/or 106 may be located in a system 100 (FIG. 1) in which the instructions are executed, or may be located in a second system that connects to system 100 over a network. In this later instance, the second system provides the instructions to system 100 for execution.

System 100 may take various forms. In general, system 100 can encompass any device having a processor 102 that executes instructions from a memory medium 106. Instructions for implementing a system as described herein can be received by the system via a carrier medium. The carrier medium may include the memory media or storage media of the type described above in addition to a communication medium such as a network and/or wireless link which carries instructions as signals such as electrical or electromagnetic signals.

A Boolean function that models a cluster of the technology-independent network is referred to herein as a target function f. A Boolean function modeling a library cell cᵢ is referred to herein as a pattern function fᵢ. Both target functions and pattern function fᵢ can be represented by data stored in the data memory 104 (FIG. 1). In one example, both target and pattern functions have a single output although multi-output functions can be used in other examples It is to be noted that none, one, or more than one cell may map to a given cluster.

In one embodiment of the present invention, binary decision diagrams (BDDs) are employed, directly or indirectly, in building models of the library cells and/or the candidate clusters. In one example of such an embodiment, reduced ordered BDDs (ROBDDs) are employed directly or indirectly, in building models of the library cells and/or the candidate clusters. The following description refers to ROBDDs, it being understood that the present invention should not be limited thereto.

A variable assignment Aₖ, as the term is used herein, from a Boolean vector X={x₁, x₂, . . . xₙ} to a Boolean vector Y={y₁, y₂, . . . yₙ} is a bijection between X and Y where for each index i and j, yⱼ=Aₖ(xᵢ) and xᵢ=Aₖ⁻¹(yⱼ). Each bijection may be enumerated as follows: A1, A2, . . . Aₖ, and the index “k” corresponds to the enumeration index. So the notation (Aₖ )ₖ means that it is a list of elements Aₖ with a variable “k” , e.g. (A1, A2, . . . Aₖ, . . . ). Since it is a bijection from a vector of n elements to a vector of n elements, there will be n! bijections, from A1 to An!. Y=Aₖ(X) is referred to herein as the assignment from X to Y. Lamda(X,Y) is the set of all possible variable assignments (Aₖ )from X to Y.

Letƒ be a Boolean target function and let vector Xbe the input variables ofƒ (i.e., f=f(X). The ROBDD built on the function f(Y=_{Ak}(X)) with the ordering (y₁< . . . <yᵢ . . . <yₙ) is referred to herein as a canonical representant ofƒ upon vector Y for variable assignment Aₖ and is designated R_{Y}=_{Ak(X)}(f). The canonical representant set ofƒ upon a set of variables Y=(y₁, , . . yₙ) is designated CRS_{XY}(f) for each Aₖ which is an element of lamda(X,Y).

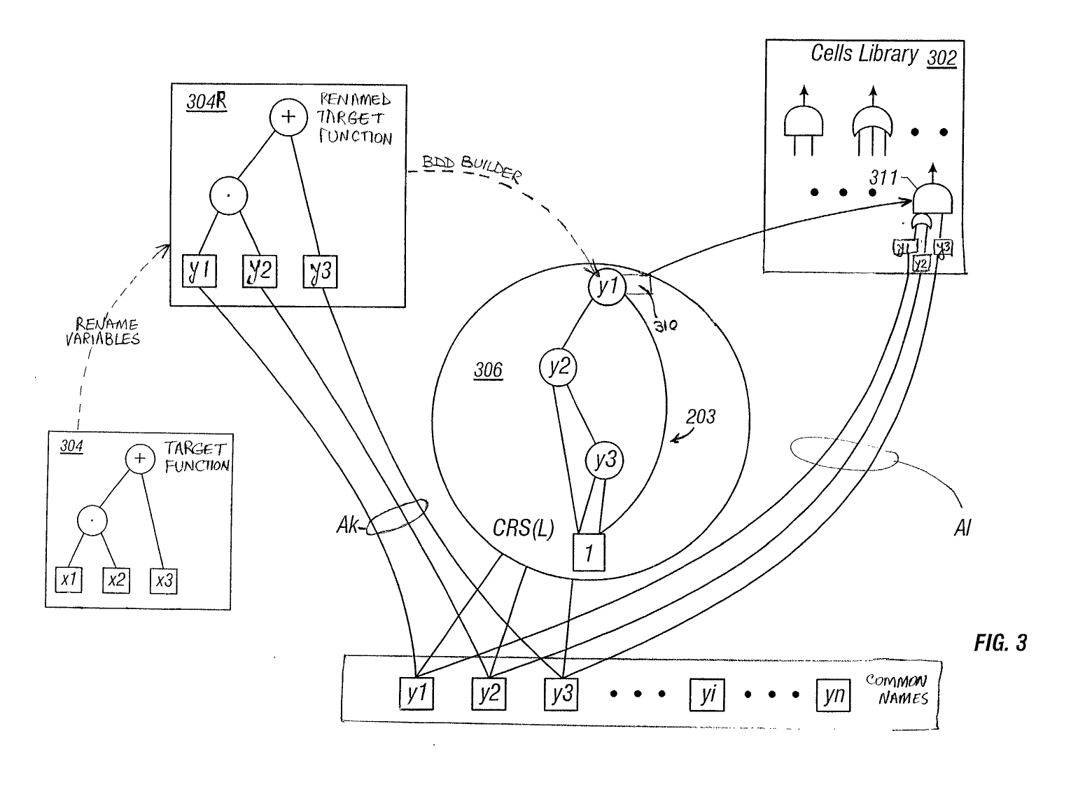

FIG. 2 illustrates a set 200 of ROBDD representants (ROBDDRs) for an example target functionfhaving three input variables, f=x₁·x₂+x_{3 where “·” represents a logical AND and “+” represents a logical OR, and x}₁, x₂ and x₃ represent original variable names. ROBDDR 201 for the example target Boolean function corresponds to replacement of original names x₁, x₂ and x₃, with the new names y₁, y₂ and y₃ as follows: (y_{1=A}₁(x₁), y_{2=A}₁(x₂), y₃=A₁(x₃)) and (y₁=A₂(x₂), y₂=A₂(x₁), y₃=A₂(x₃)). Note that variable assignments A₁ and A₂ differ only in the order of the first two variable names, while the third variable name is unchanged. For this reason, a single ROBDDR 201 represents both variable name assignments A₁ and A₂. Similarly, ROBDDR 202 corresponds to variable assignments (y₁=A₃(x₁), y₂=A₃(x₂) y₃=A₃(x₃)) and (y₁=A₄(x₂), y₂=A₄(x₃), y₃=A₄(x₁)). Finally, ROBDDR 203 corresponds to variable assignments (y₁=A₅(x₃), y₂=A₅(x₁), y₃=A₅(x₂)) and (y₁=A₆(x₃), y₂=A₆(x₂), y₃=A₆(x₁)). It is noted that the ROBDDR set 200 for f=x₁·.x₂+x₃ has three members ROBDDRs 201, 202 and 203 rather than six since the first two input variables x₁ and x₂ are symmetric to the example target function (i.e., x₁·.x₂=x₂·x₁).

If a variable assignment Aᵢ exists from X to X' which makes a function f' (X') finctionally equivalent to a flunction f(X), then for all variable assignments Aₖ which are elements of Lamda(X', Y), the ROBDDR_{Y=Ak(x')}(f') ε belongs to CRS_{xy}(f). The converse is also true. It is also true that the canonical representant set of f' andƒ are identical. This proposition is based on the principle that if two ROBDDs are functionally equivalent then they have the same unique ROBDD representant.

If a variable assignment Aₖ. exists for which R_{Y=Ak(X′)}(f') ε CRS_{XY}(f), then there exists a variable assignment A₁ such that ROBBDR_{Y=Ak(X′)}(f')=ROBBDR_{Y=A1(X)}(f). Consequently the ordering (y₁<. . . <yᵢ< . . . <yₙ) with assignments Y=Aₖ(X′) or Y=A₁(X) produces the same ROBDDR. This means that there exists a relation between X′ and X which verifies:

[symbol]

[symbol]

As a result of the above, if the ROBDDR of a function f' with a variable assignment Aₖ is an element of set CRS_{XY}(f), then f' andƒ are functionally equivalent with the assignment Aᵢ defined by equation (2) above. This means that the functional equivalence between a target function ƒ' and a pattern functionƒ can be determined by using a single ROBDDR of f' with a variable assignment Y=Aₖ(X'). This also means that if f' andƒ are two equivalent functions, then they have exactly the same canonical representants set according to equation (2). Thus a single ROBDDR of a target functionf is used as described herein to determine whether the target ƒ' is functionally equivalent to a set of pattern functions fᵢ each having the same canonical representants set. Such use of the single ROBDDR eliminates the prior art need to check equivalents (at the end) between ROBDDs (e.g. through isomorphism, unification, truth table equivalence and string comparisons).

The canonical representant set of a cells library L upon a vector Y is designated CRS_{Y}(L). A Boolean function ƒ'(X′) has matches in the library cells if for any variable assignment Aₖ the ROBDDR_{Y=Ak(X′)}(f′) belongs to CRS_{Y}(L). Matching cells corresponding to the set Cells(ƒ'(X′)) is defined by:

Cells (ƒ'(X′))={cᵢεL/∀Aₖ, R_{Y=Ak(X′)}(f′)εCRS_{XiY}(f_{ci})} (3)

FIG. 3 illustrates implicit matching of electrical circuitry (e.g. in the form of Boolean functions) to library cells in accordance with one embodiment of the present invention. More particularly, FIG. 3 shows a cells library 302 (held in memory 104b of FIG. 1), a given Boolean function 304 (held in memory 104a of FIG. 1) corresponding to a candidate cluster to be mapped or matched to one or more cells of library 302, a CRS 306 (held in memory 104d), and new names y₁-yₙ which are used to replace the original names prior to the construction of representants of the cells of library 302 and candidate clusters. The representants of CRS 306 (FIG. 3) are built by a ROBDD builder (held in memory 106 of FIG. 1) from functions representing cells in library 302 with inputs renamed to y₁-yₙ. Pointers (e.g. pointer 310) are used to identify a relation between representants of CRS 306 and cells of library 302.

Input names x₁-x₃ of the Boolean function 304 (that are to be mapped to library 302) are renamed to y₁-y₃, which are the same variable names used in CRS 306. Boolean function 304 with renamed input variables is illustrated as function 304R in FIG. 3, and this function 304R is provided to the ROBDD builder (not shown in FIG. 3). Before the ROBDD builder builds a representant from Boolean function 304R, the ROBDD builder checks CRS 306 first to determine whether a previously built representant exists that corresponds to the Boolean function 304R. Such checking is an integral part of most prior art ROBDD builders, and is normally performed to screen out duplicate ROBDDs. In FIG. 3, at least one previously built representant 203 is determined to exist for the Boolean function 304R. Pointer 310 links this previously built representant 203 to at least one corresponding cell 311 in library 302. This one cell 311 is therefore mapped to the Boolean function 304.

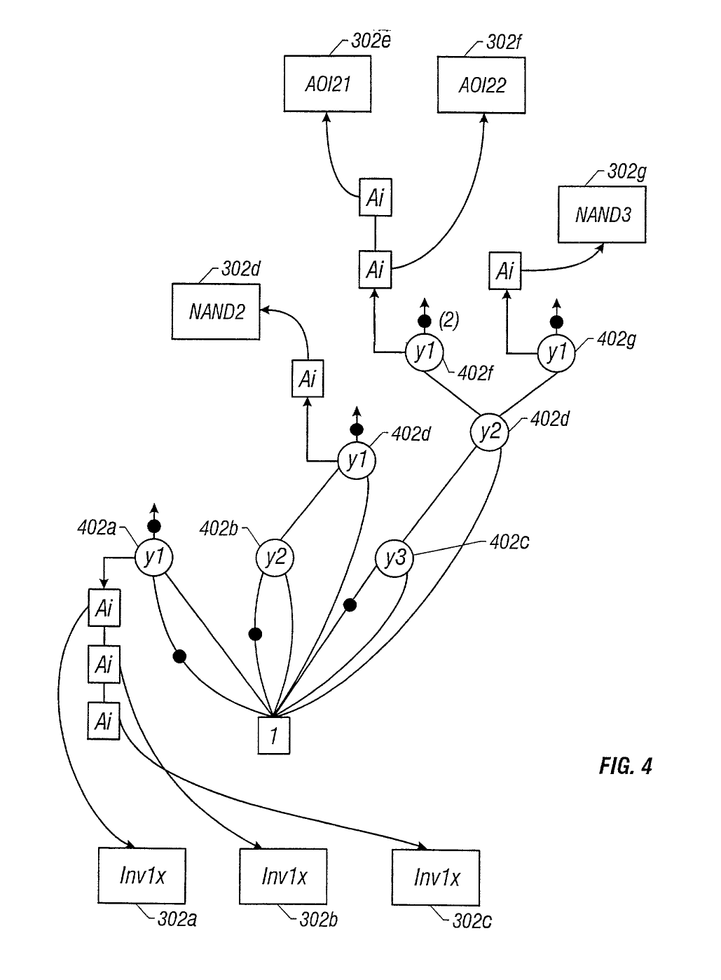

FIG. 4 shows a more detailed example of CRS 306 with pointers to cells. In FIG. 4, for each representant root node 402a- 402g, there is a list of cells 302a-302g of library 302 whose functions correspond to this representant. For each pointed cell function cs there is an assignment or ordering Aᵢ between the original input names X of g_{ci} and the new names Y. For instance the root node 402a points to cells 302a-302c. Root node 402ƒ points to cells 302e and 302f. Since this information is accessible at the BDD node level, the BDD node structure is extended in this embodiment in order to save pointer 310.

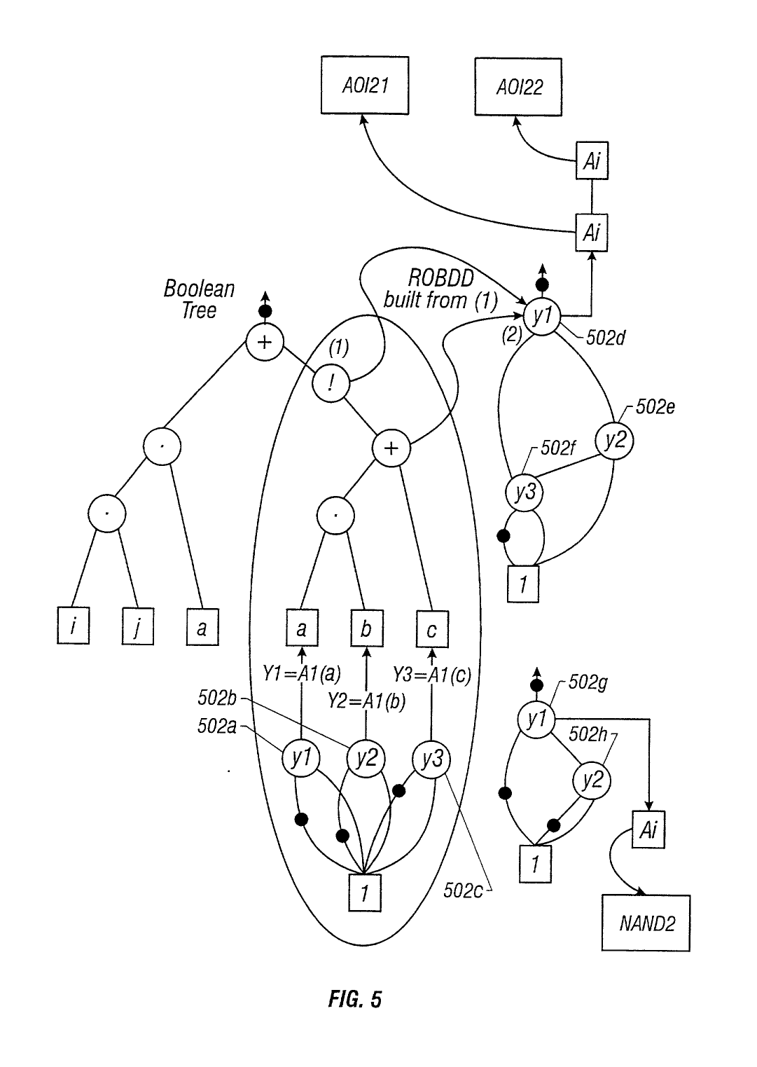

FIG. 5 illustrates a more detailed example of implicit matching in accordance with one embodiment of the present invention. Given a compatible assignment or ordering Aₖ and a function ƒ'=!(a.b+c) corresponding to node 502d of FIG. 5, a compatible assignment can be (y₁=A1(a)·y2 =A1(b),y3 =A1(c)) or Y=A1(X′) where X'={a,b,c}. Then the representant of f_{' with its input names replaced may have a root node which is node 402}ƒ of FIG. 4 or 502g or FIG. 5. Moreover, from this root node one or more cells which can realize function ƒ' may be identified since the one or more cells can be accessed from BDD nodes 402ƒ or 502g. To know the variable assignment betweenf and a gate cᵢ, A₁ may need to be composed (as defined in equation 2) with the variable assignment Aᵢ pointing on cᵢ.

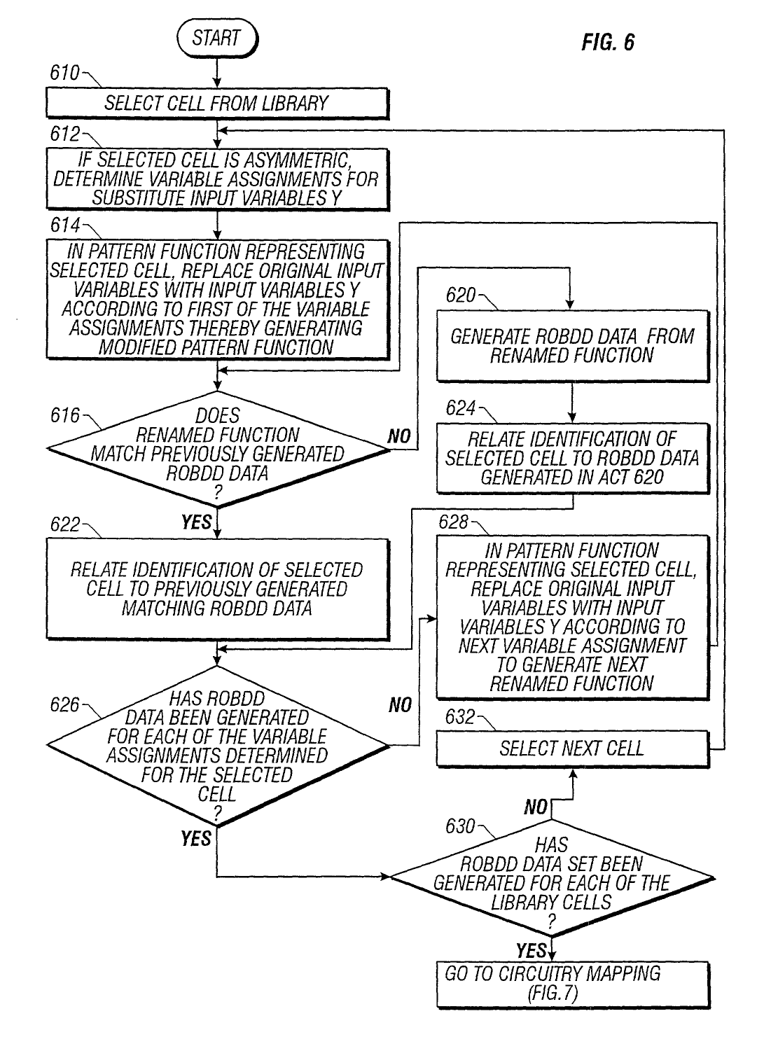

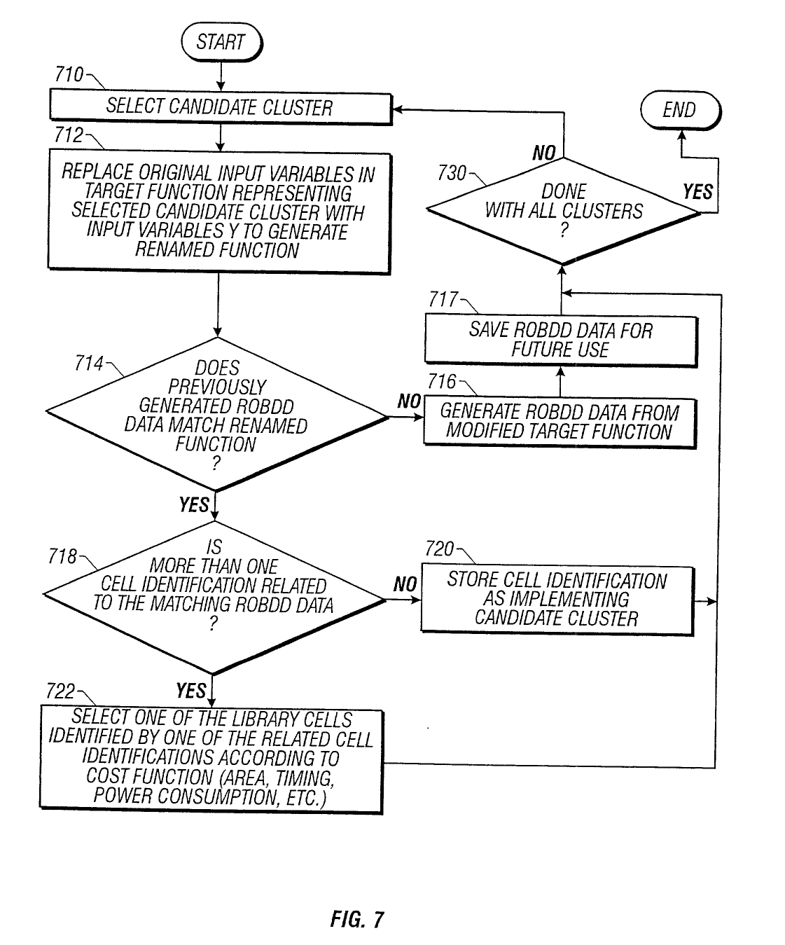

To implement the process, ROBDD representants or models of the library cells are first formed using a ROBDD builder. FIG. 6 illustrates, in flow chart, one embodiment for building library models. More particularly, microprocessor 102 (FIG. 1) begins, in act 610, with the selection of one of the cells of the technology-dependent library stored in memory 104. In act 612, the number of different variable assignments Aₖ of substitute input variables Y for the selected cell is determined, if the selected cell is asymmetric. If the selected cell is not asymmetric, there is only one variable assignment. Input variables Y, or a subset thereof, may be the original input variables of the selected cell (e.g. if the original names are unique relative to one another), in which case nothing is done in act 612 for symmetric cells. It is noted that input variables Y, or subsets thereof, will be commonly used in this embodiment in generating models of a majority or all of the cells of the library (as discussed below in reference to act 620). Additionally, it is noted that input variables Y. or subsets thereof, will be used in this embodiment in constructing models of circuitry (as described below in reference to FIG. 7).

In act 614, the input variables of the pattern function f_{ci} representing the selected cell, are replaced with the input variables according to the first of the variable assignments determined in act 612. By replacing the input variables with the input variables Y, a renamed pattern function is created. Thereafter in act 616, a decision is made as to whether the renamed function matches a previously generated ROBDDR. If no previously generated ROBBDR exists which matches the function, then ROBDDR is generated for this function in act 620 and then in act 624 the selected cell is related to the ROBDDR. This relationship may be stored in memory 104 for future reference. It is noted that different pattern functions may produce identical ROBDDRs. If the renamed function matches previously generated data (e.g. if two cells are isomorphic to one another), then in act 622, an identification (e.g., memory address) of the selected cell is related to the previously generated ROBDDR. Again, this relationship may be stored in memory 104 for future reference.

In one example, the BDD data structure is extended over the prior art structure to hold the memory address of a cell, and the cell data structure is also extended to hold the memory address of an isomorphic cell. In other examples, other kinds of data structures (such as another linked list that maps a BDD pointer to a cell pointer) can be used, e.g. if source code of the ROBDD builder is not available to allow expansion of the BDD data structure.

In act 626, a determination is made as to whether a ROBDDR has been generated for each pattern function modified according to the variable assignments determined in act 612. If it is determined that a ROBDDR has not been generated for each variable assignments determined in act 612, then in act 628 the input variables of the pattern function representing the selected cell, are again replaced with the input variables Y according to the next variable assignment, thereby generating a next renamed function. Thereafter, acts 616-626 are repeated for the next renamed function. However, if it is determined that a ROBDDR has been generated from each modified pattern function, then in act 630 a determination is made as to whether a complete ROBDDR and/or corresponding ROBDDR memory address set has been generated for each of the cells of the library. If not, the next cell in the library of cells is selected in act 632. Thereafter, acts 612-630 are repeated. However, if all or substantially all of the ROBDDRs have been generated, the process of modeling the cell library ends.

Note that several of the acts illustrated in FIG. 6 can be performed by a ROBDD builder (also called “BDD package”) in a manner well known in the art (e.g. acts 610, 620 and 616). Next, all matches of a given Boolean target functionƒ to one or more cells may be found using a single ROBDDR construction of f, where the construction of the single ROBDDR and/or memory thereof is performed by the ROBDD builder using the target function ƒ with its input variables replaced by the same input variables Y, or a subset thereof, used in generating the models of the library cells set forth above (presuming the original input variables of the target function are not Y. or a subset thereof).

The complexity of mapping a given Boolean function depends mainly on the method of representing the Canonical Representant Sets, and the sets can be large for cells or representative pattern functions having many variable inputs. The size of the Canonical Representant Set can be reduced if the number of possible assignments of variable names is reduced. By considering canonical signatures on each original input variable name of the library cells, some possible assignments are eliminated in some examples.

Let S(x₁) be an integer which is a canonical signature of input variable xᵢ in function ƒ(X). Then CRSx_{y}(ƒ) is restricted to representants ROBBDR_{y=Ak(X)}(ƒ) such that Aₖ verifies:

∀m, n (yₘ<yₙ) [symbol] (S(Aₖ⁻¹(yₘ)) [symbol] S(Aₖ⁻¹(yn))) (4)

Aₖ is said compatible with respect to signature S if equation (4) above is verified. Aₖ will be referred to herein as a compatible assignment.

The signature S(xᵢ) used here corresponds to the number of mintems of the function fₓᵢ, e.g. the cofactor of ƒ with respect to input variable xᵢ. This signature is computed on a ROBDDR of ƒ and is linear in terms of the number of ROBDD nodes. In the example illustrated in FIG. 2, the following signatures are extracted: S(x₁)=3, S(x₂)=3, S(x₃)=4. The set of possible assignments for ƒ are then (y₁=A₁(x₁), y₂=A₁(x₂), y₃=A₁(x3)), and (y₁=A₂ (X₂), y₂=A₂(x₁), y₃=A₂(x₃)) and the other assignments are eliminated because there are not compatible with signature S. Then CRS_{xy}(ƒ) has one single element which is the ROBDD 201 of FIG. 2.

The ROBDD construction of a target functions with a compatible assignment Aₖ also belongs to CRS(L), if L is the target library. Therefore, considering only compatible assignments when constructing ROBDDs for both pattern functions and target functions has reduced the number of representants being processed.

Given a compatible assignment Aₖ and a functionf corresponding to the node 201 in FIG. 2, then ƒ =!(a b +c), a compatible assignment can be (y_{1=A}₁(a),y₂=A₁(b),y₃=A₁(c) or Y-A₁(X) where X′={a,b,c}. Thenthe ROBDDR_{Y=A1(X′})(ƒ) has a root node which is exactly the root node 402a of FIG. 4. Moreover, from this root node the method inherits directly and implicitly all of the cells which can realize the functions ƒ′ since it can access all the cells from bdd node 202. Note that the cells found can realize the function or its complement because of the Types ROBDD representation. Generally speaking, NPN function solutions are treated in this way: Output Inversion with typed ROBDD structure, Input permutation with Canonical Representant Set, Input inversions with double-inverters insertions. Finally, to know the variable assignment betweenf and a gate cs, the method composes (as defined in equation (4)) A₁with the variable assignment Aₖ pointing on cᵢ.

In terms of complexity, the implicitpattern matching for a function ƒ against a library cells L needs only to identify a compatible assignment variable Aₖ (e.g. computing signature for each variable xᵢ of the support of ƒ which can be done by computing a Bdd of ƒ) plus the construction of ROBDDR_{Y=Ak(X′)}(ƒ′). In the worst case, two ROBDDs constructions are necessary to find all the cells cᵢ which match ƒ but one ROBDD construction can be enough because signatures can be also computed on R_{Y=A1(X′)}(ƒ′) itself where for each i, yᵢ=A_{I}(xᵢ). If by “chance” A_{I} is compatible with S, then one construction is enough. Practically, this is the case when function has a lot of symmetric variables (ex: Nand2, Nand3, ... needs only 1 ROBDD construction). If the max fan in of the library L is n, then the two ROBDDs can have a maximum size of 2ⁿ/n bdd nodes.

FIG. 7 is a flow chart illustrating one embodiment of the present invention for a computer to automatically map candidate clusters (represented by target function ƒ)to cells in a library L. More particularly, in act 710, a candidate cluster of a network is selected by microprocessor 102 (FIG. 1). Thereafter in act 712, the original input variables of the target finctionfrepresenting the selected candidate cluster are replaced with the input variables Y to generate a renamed function. Note that Y is identical to the Y used for modeling the cell library.

In act 714, a determination is made as to whether the ROBDDR that was previously generated matches the renamed function. If no such ROBDDR exists, microprocessor 102 generates ROBDD data from the renamed function in act 716 and saves the generated data (e.g. in memory 104c of FIG. 1) for future use in act 717. However, if such previously generated ROBDDR exists, identifiers of all cells related to the previously generated ROBDDR are read from memory 104. In act 718, a determination is made as to whether more than one cell identification is related to the matching ROBDD data. If only one identifier is read from memory, then the cell identified by the identifier is mapped to the candidate cluster selected in act 710, as shown in act 720. However, more than one cell identifier relating to the previously generated ROBDDR may exist. In this case, as shown in act 722, one of the library cells previously related to the ROBDDR is selected according to a cost function, such as the area occupied by the cell if implemented on silicon, the speed at which the cell operates, the power consumption of the cell, etc. The acts 710-720 set forth in FIG. 7 are repeated (see act 730) for several of the candidate clusters in the Boolean logic network. Thereafter, the method ends.

The implicit pattern matching has been implemented in a tool illustrated in Appendices A-E which does quick and efficient synthesis. This tool, including the implicit pattern matching engine and the BDD package, has been written in the C language. Experimental tests have been performed on HP 735/126. These results give the optimum solution in terms of Area when mapping MCNC benchmarks with library lib2. lib. For each node, all the matching cells are identified by the implicit pattern matching procedure and then a recursive dynamic programming approach is used to get the optimum. Two options are run. A first option starts from an original netlist where single local variables are collapsed and where the general Boolean tree is transformed into a classical 2-AND/INV tree. A second option starts almost from the same 2-AND/INV Boolean tree except that for each edge between two nodes a double inverter INV is inserted. This insertion is useful to capture input polarities. This second option is better than first option because the starting Boolean tree description has been refined.

Experiments for some samples show the number of ROBDD constructions is about 1.9 times the numbers of target functions which is in practice the general cost to perform all the matches. Moreover the number of target functions increased a lot between first option and second option but then the number of cells found is much more important which leads to a larger exploration space. In experiments on other samples, the first option clearly shows an important speed-up in terms of CPU time and area improvement compared to TEMPLATE and SIS 1.3. The speed-up is about 38 times faster (resp. 114 times) than SIS 1.3 (resp. TEMPLATE) and the gain in terms of Area is about 11.1% (resp. 3%).

Regarding the second option, the CPU time is the same as SIS 1.3, and 3 times faster than TEMPLATE. The area gain in about 19.2# better than SIS 1.2 and 11.1% better than TEMPLATE. Note that sometimes the second option can drastically improve results compared to the first option. The results given by the second option are ‘a priori’ the optimum but it is not the case for circuit pair since TEMPLATE is better. This must come from the fact that the original Boolean networks are probably not the same. In one experiment, both original gates and following configured gates are used in second option. In the configured case, results are not much improved because with this library most of the configured cells can be built with original library cells with less cost. Note that the increase of the number of considered cells between the two cases has almost no impact on the CPU time. Only the time to build the library is a little bit longer (1 s. vs. 12 s.).

Any BDD package of the prior art can be used in the manner described herein, with the addition of an external table that relates a BDD node to a library cell. Such an external table can be implemented using a hash function, and is used to look up a cell from the signature of a BDD. For example, a hash table can store a couple of the form (bdd_node, attach_info) where the ‘bddnode’ is the BDD node and the attachinfo the lib.cell with the permutation info. Each couple is stored in the hash table according to the signature of the BDD node ‘bdd_node’. When it is necessary to know if a BDD node ‘x’ is linked to a library cell microprocessor 102 looks in the hash table (instead of having directly the link through the BDD structure field) to retrieve the library cell. In using the hash table case, microprocessor 102 incurs an overhead compared to a direct attachment of a cell to the BDD node (as described next) because it will take some time to insert a couple and to retrieve it.

If source code for a BDD package is available, there is no need to use an external table. Instead, a data structure of the BDD package that defines ROBDD nodes is enlarged, by one field 310 (called “hook field”), to hold a pointer to a cell in the library, which cell is the one that was used to generate the ROBDD as illustrated in FIG. 4. One example of hook field 310 is illustrated in file ‘bbdd.h’ of the attached Appendix B, in the structure BDD (typedef struct BDD_STRUCT {. . . ). The hook field is used through the macro function (see file bbdd.h):

| | |
|---|---|
| #define GetBddPtrHook(BddPtr) | ((BddPtr)−>Hook) |
| #define SetBddPtrHook(BddPtr, H) | ((BddPtr)−>Hook = H) |

The structure stored on the ‘hook’ field is of type: LIB_BDD_INFO and is used in file gnllib.c (described above):

—LibBddlnfoCreate

—GnlResetBddHook

—GnlComputeBddMinterms

—GnlVarHasSymmetricVar

—GnlGenerateDerivedCellRec

—GnlGetlnverters

—GnlGetSizeOffasicEquivalentGate and in gnlmap.c: (the technology mapping itself):

—GnlGetBestAreaCellOnNode/* use in techology mapping AREA */

—GnlGetBestPowerCellOnNode/* use in technology mapping POWER */

—GnlGetBestNLDelayCellOnNode/* use in technology mapping DELAY */

—GnlGetBestDepthCellOnNode/* mapping but not used */

—GnlGetBestNetCellOnNode/* mapping but not used */

Therefore, any bdd package can be used as described herein, regardless of whether or not it provides the capability to attach a cell to a BDD node. Although the present invention has been described in connection with several examples and embodiments, the invention is not intended to be limited to the specific forms set forth herein. For example, instead of building cell models with all permutations of names for an asymmetric cell, another embodiment uses just a single order of names and models the cluster being mapped with each of a number of permutations of names, until a matching model is found. As another example, variable names of input signals to both clusters and cells need not be replaced if input signal names of cells are used as the common names (so that only the names in clusters are replaced). Furthermore, as yet another example, no replacement need be done at all if variable names of input signals to both clusters and cells are common ab initio, for example if a CAD tool used to design the circuit formed by the clusters is programmed to use the names being used in the cells. Also, several of the acts described herein can be performed automatically one after another in the normal manner of a computer program, or one or more acts may be performed after receiving certain manual inputs (or instructions). Numerous such variants will be apparent to the skilled artisan in view of the disclosure.

Numerous alternatives, modifications, and equivalents of the embodiments and implementations described herein are encompassed by the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method of describing a to-be-built integrated circuit, the method comprising:
reading first data from memory, wherein the first data corresponds to a first cell of a plurality of cells in a library used in manufacturing said integrated circuit, wherein the first data comprises a plurality of names of a corresponding plurality of signals input to the first cell; and
replacing each name in the first data with one of a plurality of new names, respectively, thereby to obtain first renamed data.

2. The method of claim 1 further comprising passing the first renamed data to a predetermined function for generating at least a first model for said first cell.

3. The method of claim 2 further comprising relating an address in a cell library of the first cell with the first model obtained after said passing.

4. The method of claim 3 wherein said first model has a field, and the act of relating comprises:
storing said address in said field.

5. The method of claim 1 wherein after said replacing, the method further comprises replacing each of the names in the first data with one of the plurality of new names, respectively, in a second order different from a first order of said new names used to obtain the first renamed data, thereby to obtain second renamed data.

6. The method of claim 5 further comprising:
passing the first renamed data to a predetermined function for generating first model;
passing the second renamed data to said predetermined function for generating second model;
relating an address of the first cell to the first model; and
relating said address to the second model.

7. The method of claim 1 further comprising:
repeatedly replacing each of the names in the first data with one of the plurality of new names, respectively, in an order different from a previous order used in a previous act of replacing; and
repeatedly passing renamed data obtained from said act of repeatedly replacing to said predetermined function.

8. The method of claim 1 further comprising:
reading second data from memory, wherein the second data corresponds to a second cell of the plurality of cells, wherein the second data comprises a plurality of names of a corresponding a plurality of signals input to the second cell; and
replacing each name in the second data with one of new names, respectively, thereby to obtain second renamed data.

9. The method of claim 8 further comprising:
passing the first renamed data to a predetermined function for generating first BDD or ROBDD data;
passing the second renamed data to said predetermined function for generating second BDD or ROBDD data;
relating an address of the first cell to the first BDD or ROBDD data; and
relating an address of the second cell to the second BDD or ROBDD data.

10. The method of claim 1 further comprising:
reading second data from memory, wherein the second data corresponds to a portion of a network to-be-built of interconnected circuits, wherein the second data comprises a plurality of names representing a plurality of signals input to the portion; and
replacing each name of the second data with one of a plurality of new names, respectively, thereby to obtain second renamed data.

11. The method of claim 10 further comprising:
passing the first renamed data to a predetermined function for generating first BDD or ROBDD data; passing the second renamed data to said predetermined function for generating second BDD or ROBDD data;
comparing the first BDD or ROBDD data with the second BDD or ROBDD data within said predetermined function; and
relating the network portion to the first cell if the first BDD or ROBDD data compares equally with the second BDD or ROBDD data, respectively.

12. The method of claim 10 further comprising:
comparing the second data to a plurality of previously generated models, respectively, wherein each of the plurality of previously generated models is respectively related to one of the plurality of cells;
relating one of the plurality of cells to the network portion in response to comparing the models to the plurality of previously generated models.

13. A computer readable storage medium encoded with computer instructions to perform the reading and replacing of claim 1.

14. A signal in a carrier medium encoded with computer instructions to perform the reading and replacing of claim 1.

15. A method comprising:
reading first data from memory, wherein the first data corresponds to a portion of a network to-be-built of interconnected circuits, wherein the first data comprises a plurality of names representing a plurality of signals input to the portion;
replacing each name of the first data with one of a plurality of new names, respectively, thereby to obtain second renamed data.

16. The method of claim 15 further comprising:
passing the first renamed data to a predetermined function for generating BDD or ROBDD data;
the predetermined function comparing the BDD or ROBDD data to a plurality of previously generated BDD or ROBDD data, respectively, wherein each of the plurality of previously BDD or ROBDD data is respectively related to one of a plurality of cells used in manufacturing said network to be built; and relating one of the plurality of cells to the network portion in response to comparing the BDD or ROBDD data to the plurality of previously BDD or ROBDD data.

17. A computer readable storage medium encoded with:
data related to BDD or ROBDD; and
memory address of a cell in a library of cells used in manufacturing an integrated circuit, said cell being modeled by said BDD or ROBDD.

18. The computer readable storage medium of claim 17 wherein:
the memory address is located adjacent to the data, and accessed via a single data structure.

19. The computer readable storage medium of claim 17 further comprising:
a table relating to the memory address.

20. A computer system comprising:
a microprocessor coupled to first and second memories;
wherein the first memory comprises a plurality of names of a corresponding a plurality of input terminals of cells of a technology library;
wherein the second memory comprises instructions executable by the microprocessor for implementing a method for replacing each name in one of the plurality of cells with one of a plurality of new names.

21. The computer system of claim 20 wherein:
the first memory further comprises a plurality of names of input terminals of a corresponding plurality of clusters of a to-be-built electrical circuit; and
the second memory further comprises a BDD package, a first instruction to invoke the BDD package for at least one cell and a second instruction to invoke the BDD package for at least one cluster.

22. A computer readable medium storing a relationship between BDD or ROBDD data and at least one cell of a plurality of cells used in manufacturing an integrated circuit, wherein the BDD or ROBDD data was generated from data representing the at least one cell.

23. The computer readable storage medium of claim 22 further comprising an instruction to replace each name of each input signal of each cell with a new name.
